(19) United States
(12) Patent Application Publication
(10) Pub. No.: US 2011/0029439 A1
(43) Pub. Date: Feb. 3, 2011

(54) High throughput research workflow

(76) Inventors: Flor A. Castillo, Lake Jackson, TX (US); Jeffrey D. Sweeney, Midland, MI (US); Wayne E. Zirk, Dunbar, WV (US)

Correspondence Address: The Dow Chemical Company;Brooks, Cameron, PLLC, 1221 Nicollet Avenue, Suite 500, Minneapolis, MN, 55403, US

(21) Appl. No.: 12/590,870

(22) Filed: Nov. 16, 2009

Related U.S. Application Data
(60) Provisional application No. 61/199,642, filed on Nov. 19, 2008.

(51) Int. Cl. G06Q 10/00

(52) U.S. Cl. 705/300; 705/301

(57) ABSTRACT

Methods and structures having and/or implementing integrated steps for use in a planning phase of high throughput research which can provide a process flow that can be used provide statistically defensible and reproducible data in high throughput research. The integrated steps can include quantifying systematic variation in a high throughput research system that is to process a candidate, wherein the high throughput research system has at least one physical attribute and at least one environmental attribute, identifying a design objective for the candidate, and providing an experimental design for the candidate that accounts for the systematic variation to produce the statistically defensible results.

This application claims priority from U.S. Provisional Application Ser. No. 61/199,642 filed Nov. 19, 2008, the entire content of which is incorporated herein by reference.

### FIELD OF DISCLOSURE

Embodiments of the present disclosure are directed toward high throughput experimentation; more specifically, embodiments of the present disclosure include methods and structures having and/or implementing integrated steps which can provide a workflow that can provide statistically defensible and reproducible data in high throughput research.

### BACKGROUND

High throughput research, also referred to as high throughput experimentation, is an increasingly important tool for the development of new compounds. High throughput research can be thought of as an application of various high throughput techniques, such as combinatorial chemistry or high throughput screening, in conjunction with various instrumentations, such as robotics and software platforms. The practice of high throughput research can lead to the development of new compounds that can include catalysts, polymers, electronic materials, and biomaterials.

As with other industries, demands for higher productivity, lower costs, and greater development speeds continue to drive the search for new technologies, methods, and systems in high throughput research.

High throughput research can be divided into three distinct phases, the planning phase, the execution phase, and the analysis phase. Some contributions to the art have been made in the execution and analyzation phases of high throughput research, but the critically important planning phase of high throughput research is currently lacking in providing reliable and statistically defensible results while efficiently using resources and maximizing information content.

### SUMMARY

Embodiments of the present disclosure include methods and structures having and/or implementing integrated steps which can provide a workflow that can produce statistically defensible and reproducible data in high throughput research.

The various embodiments can include quantifying systematic variation in a high throughput research system that is to process a candidate, wherein the high throughput research system has at least one physical attribute and at least one environmental attribute, identifying a design objective for the candidate, and developing an experimental design for the candidate that accounts for the systematic variation to produce the statistically defensible results.

Embodiments of the present disclosure can include developing an experimental design for the candidate that accounts for randomization restrictions to produce the statistically defensible results.

For the various embodiments, quantifying systematic variation can include performing a variance component analysis on the high throughput research system.

Embodiments can include modifying a source of systematic variation within the high throughput research system to change the systematic variation.

For the various embodiments, developing the experimental design for the candidate includes developing at least one of a screening design, a split plot design of experiment, or a classical design of experiment.

Embodiments of the present disclosure can include a computer readable medium having instructions stored thereon for causing a computing device to perform a method including quantifying systematic variation in a high throughput research system that is to process a candidate, identifying a design objective for the candidate, and developing an experimental design for the candidate that accounts for the systematic variation produce the statistically defensible results.

Embodiments of the present disclosure also include a computing device including a processor, a memory in communication with the processor, and computer executable instructions stored in the memory and executable by the processor to perform a variance component analysis on a high throughput research system that is to process a candidate, identify a design objective for the candidate, and develop an experimental design for the candidate that accounts for the systematic variation to produce the statistically defensible results.

The above summary of the present disclosure is not intended to describe each disclosed embodiment or every implementation of the present disclosure. The description that follows more particularly exemplifies illustrative embodiments. In several places throughout the application, guidance is provided through examples, which can be used in various combinations. In each instance, the recited examples serve only as a representation and should not be interpreted as exclusive.

### DEFINITIONS

As used herein, “a,” “an,” “the,” “at least one,” and “one or more” are used interchangeably. The terms “includes” and “comprises” and variations thereof do not have a limiting meaning where these terms appear in the description and claims. Thus, for example, modifying a source of systematic variation, “a” source of systematic variation can be interpreted to mean that there may be “one or more” sources of systematic variation.

The term “and/or” means one, one or more, or all of the listed elements.

Also herein, the recitations of numerical ranges by endpoints include all numbers subsumed within that range (e.g., about 1 to about 5 includes 1, 1.5, 2, 2.75, 3, 3.80, 4, 5, etc.).

As used herein, the terms “workflow” and “workflow process” refer to a sequence of operations, procedures, or a step or stage in the sequence of operations inclusive of the attributes of the operation, procedure, step, or stage of a high throughput research system, that is or can be performed by or through a person, a machine, a robot, or a combination thereof.

As used herein, the term “high throughput research system” refers to a combination of machines, robots, hardware, software, laboratory accessories, experimental accessories, and persons that can follow a workflow to “process” a “candidate”. A high throughput research system will have at least one physical attribute, such as a machine, and at least one environmental attribute, such as an atmospheric condition wherein the high throughput research system is located.

As used herein, the term “candidate” refers to a substance and/or physical material that is combined, mixed, or processed in the high throughput research system.

As used herein, the term “process” means to subject a candidate to physical or chemical conditions via the high throughput research system. The physical or chemical conditions can be constant or variable. Processing also includes analyzing a candidate at a point in time or over the course of time.

As used herein, the term “systematic errors,” also referred to as “systematic variance,” are errors that can exist within and/or throughout a series of steps, such as the steps of a high throughput research workflow, or errors associated with high throughput equipment. A systematic error is an error that is predictable once found.

### BRIEF DESCRIPTION OF THE FIGURES

FIG. 1 is a block diagram illustrating elements of an embodiment of a method for providing a workflow to produce statistically defensible data according to the present disclosure.

FIG. 2 is a block diagram illustrating elements of an embodiment of a method for providing a workflow to produce statistically defensible data according to the present disclosure.

FIG. 3 is a block diagram illustrating elements of an embodiment of a method for providing a workflow to produce statistically defensible data according to the present disclosure.

FIG. 4 illustrates a computer system that includes a computer readable medium and a computing device suitable to implement a method, in accordance with embodiments of the present disclosure.

FIG. 5 is a graph illustrating differing mean concentrations in upper rows (U) and lower rows (L) for experiments conducted in a high throughput research system, in accordance with embodiments of the present disclosure.

FIG. 6 illustrates differences between identical candidates that are potentially falsely identified, in accordance with embodiments of the present disclosure.

FIG. 7 illustrates an analysis plot based on data collected when using an assignment and blocking unavoidable variation, in accordance with embodiments of the present disclosure.

### DETAILED DESCRIPTION

The production of statistically defensible data from a high throughput research system can be achieved with validation of the workflow. However, the workflow can be the most likely source of error in high throughput research systems. For example, there is potentially dramatic variation introduced into a high throughput research system through changes in sample size and/or by streamlining sample processing associated with high throughput research systems that may be realized from the transition from conventional experimentation to high throughput research. The present disclosure provides a method for systematically addressing the problems associated with the scale-down of sample processing and the uniform application of processing steps in equipment that can be found in high throughput research system applications.

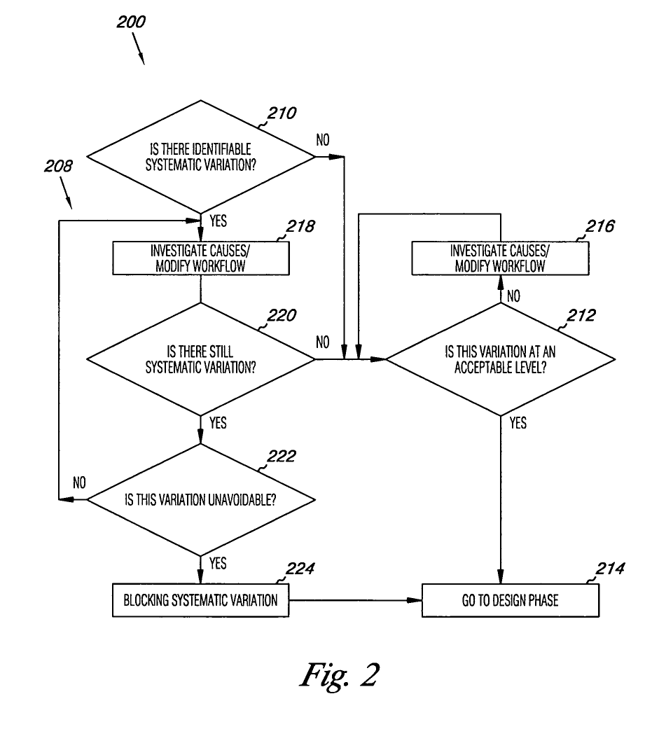

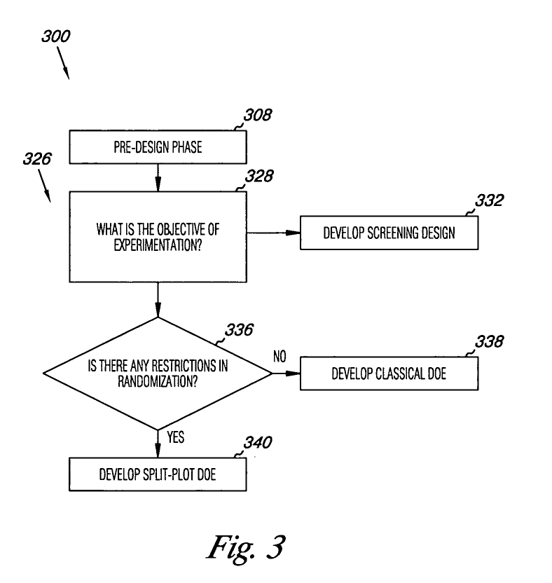

The Figures herein follow a numbering convention in which the first digit or digits correspond to the drawing Figure number and the remaining digits identify an element or component in the drawing. Similar elements or components between different Figures may be identified by the use of similar digits. For example, 208 may reference element “08” in FIG. 2, and a similar element may be referenced as 308 in FIG. 3. As will be appreciated, elements shown in the various embodiments herein may be added, exchanged, and/or eliminated to provide any number of additional embodiments. In addition, as will be appreciated the proportion and the relative scale of the elements provided in the figures are intended to illustrate the embodiments of the present invention, and should not be taken in a limiting sense.

The present disclosure includes embodiments that provide a method for providing a workflow to produce statistically defensible data. Embodiments can provide a workflow for high throughput research system applications.

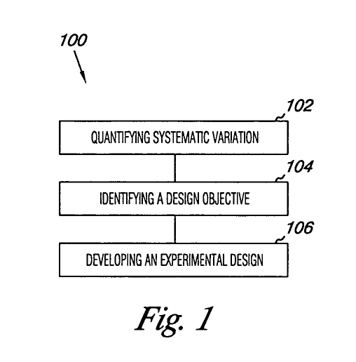

FIG. 1 is a block diagram illustrating elements of an embodiment of a method 100 for providing a workflow to produce statistically defensible data according to the present disclosure.

As illustrated in FIG. 1, embodiments of the present disclosure include quantifying systematic variation 102. An example of quantifying systematic variation 102 is a variance component design provided by Montgomery, D. (2001), Design and Analysis of Experiments, New York, N.Y.: John Wiley & Sons, Chapter 12. However, as will be appreciated by one of ordinary skill in the art, a variety of variance component designs can be used to quantify systematic variation as contemplated by the present disclosure; therefore embodiments of the present disclosure are not limited to one variance component design. A variance component design can also be referred to as a variance component analysis. Furthermore, for the purposes of this disclosure, the term variance component analysis includes subsets thereof, such as gauge repeatability and reproducibility studies.

As is appreciated, quantifying systematic variation 102 can be achieved differently for different high throughput research systems. For example, different high throughput research systems can have different sources of systematic variation. Sources of systematic variation in a high throughput research system can include, but are not limited to, different plates, locations within plates such as rows, columns, and quadrants, etc., robots, measuring equipment, and operators.

The various embodiments also include identifying a design objective 104. The design objective can be identified for a candidate that is to be processed by the high throughput research system. In some embodiments, the design objective can be in accordance with a goal of the high throughput study, such as a screening objective for the candidate or as a detailed study objective for the candidate, as discussed further herein.

The various embodiments also include developing an experimental design 106. Developing the experimental design 106 can include, in some embodiments, developing at least one of a screening design, a classical design of experiment, or a split-plot design of experiment. As discussed further herein, developing an experimental design 106 can provide that the workflow associated with the high throughput research system produces statistically defensible data.

FIG. 2 is a block diagram illustrating additional elements of the method 200 for providing the workflow to produce statistically defensible data according to embodiments of the present disclosure.

Elements of the method 200 can be considered as included in a pre-design phase 208 of the method 200. An objective of the pre-design phase 208 can be to reduce systematic variation to an acceptable level.

In order to reduce systematic variation to an acceptable level, the pre-design phase 208 includes determining whether there is identifiable systematic variation associated with the high throughput research system workflow, as shown in block 210.

In some instances, there may not be an identifiable systematic variation as determined at block 210. In such instances, the method 200 can include determining whether variation is at an acceptable level, as shown in block 212. An acceptable variation level can have different values from application to application, as well as between different high throughput research systems or different high throughput research system experimental studies. Acceptable variation can be determined based on a physical interpretation of generated data and/or a capability of a measurement system applied to the high throughput research system. Acceptable variation can also be considered as variation that is low enough to allow a signal to be detected over noise, where the signal is a difference due to intentionally changing variable levels or types in an experiment, and the noise is uncontrollable variation within the process when running the same experiment. Acceptable variation can also be referred to as an acceptable signal-to-noise ratio.

In some embodiments, a method of determining an acceptable variation can implement JMP® software, available from SAS Institute, Cary, N.C. This method utilizes the JMP® equivalence test, whereby the threshold level of a variable is set such that results differing less than the set threshold level are considered equivalent, or in other words, as applied to the herein described Example, a threshold level for percent of initial sample remaining can be set to 1 percent and results that differ by less than 1 percent can be considered equivalent, and therefore be acceptable variation.

Unacceptable variation, in contrast, can be considered as variation that is too high to allow a signal to be detected over noise. Unacceptable variation can also be referred to as an unacceptable signal-to-noise ratio. When the variation is at an unacceptable level, as shown at block 212, method 200 can include identifying the cause of the unacceptable variation, and modifying the workflow to produce a workflow with variation at an acceptable level. Embodiments of the method 200 can include identifying the source of variation and modifying the workflow to reduce the variation of the high throughput research system, as shown at block 216. Examples of modifying the workflow can include modifying a physical attribute of the high throughput research system and modifying an environmental attribute of the high throughput research system. For instance, a physical attribute of the high throughput research system can be modified by replacing a component of a robot of the high throughput research system. As is appreciated, other ways of modifying either a physical attribute and/or environmental attribute are also possible.

After a cause of the unacceptable variation has been identified and modified, as shown at block 216, the method 200 can include determining whether the variation is at an acceptable level, as shown at block 212. These elements of the method 200, determining whether variation is at an acceptable level, identifying the variation, and modifying the workflow to reduce the variation can be repeated until the variation is at an acceptable level.

In some embodiments, there may be an identifiable systematic variation as determined at block 210. In such instances, the method 200 can include identifying a cause of the systematic variation and modifying the workflow, as is shown at block 218. In some embodiments, the workflow can be modified, as discussed herein, when systematic variation is quantified.

Embodiments of the method 200 can also include determining whether there is remaining identifiable systematic variation associated with the high throughput research system workflow after a modification to the workflow has occurred, as shown at block 218. As discussed herein, quantifying systematic variation can be used to determine if there is remaining identifiable systematic variation. Quantifying systematic variation can determine systematic variation via the variance component analysis, as discussed herein.

In embodiments where there is no remaining identifiable systematic variation associated with the high throughput research system workflow that follows a modification to the workflow at block 218, as determined at block 220, the method 200 can include determining whether the variation is at an acceptable level, as shown at block 212, as discussed herein.

When there is a determination that there is remaining identifiable systematic variation associated with the high throughput research system workflow that follows a modification to the workflow at block 218, the method 200 can include determining whether the remaining identifiable systematic variation associated with the high throughput research system workflow that follows a modification to the workflow at block 218 is unavoidable variation, as shown at block 222.

As used herein, unavoidable variation can be variation that can be present in the high throughput research system due to, among other things, equipment configurations in the high throughput research system. For example, equipment configurations can be present such that a specific row, a specific column, and/or a specific plate quadrant tends to produce unreliable experimental data. Unavoidable variation can be variation that can not be avoided, excluded, and/or eliminated because of restrictions in the high throughput research system and/or the workflow. Determining unavoidable variation can include an analysis of variation which can be achieved by a number of processes, as will be appreciated by one of ordinary skill in the art.

The various embodiments can also include blocking variation, as shown at block 224. Unavoidable variation can be blocked according to statistical methodologies known in the art. Blocking unavoidable variation can include blocking known sources of variation and/or randomizing unknown sources of variation. Blocking and/or randomizing, as used herein, are statistical methodologies, as understood by one of ordinary skill in the art, which can reduce biasing effects. When unavoidable variation has been blocked and/or unknown sources of variation have been randomized method 200 can include a design phase, as shown at block 214.

In embodiments where the variation is determined to be avoidable, as shown at block 222, the method 200 can include identifying a cause of the variation and modifying the workflow, as shown at block 218. The method 200 can then repeat the process of determining whether there is systematic variation and determining whether the systematic variation is unavoidable, until the systematic variation is eliminated or deemed unavoidable. The method 200 can then include determining if the variation is at an acceptable level and/or blocking systematic variation, as discussed herein.

FIG. 3 is a block diagram illustrating additional elements of a method 300 for providing the workflow process to produce statistically defensible data according to embodiments of the present disclosure.

Elements of the method 300 can be considered as included in a design phase 326 of the method. As discussed herein with reference to FIG. 2, the various embodiments can include the pre-design phase 308 and the design phase 326. An objective of the design phase 326 can be to develop an appropriate design strategy for high throughput research system experimentation.

As illustrated in FIG. 3, the method 300 can include the pre-design phase, as shown in block 308. The various embodiments can include identifying an objective of the high throughput research system experimentation, as shown at block 328. An objective of the high throughput research system experimentation can be identified, in accordance with a goal of the high throughput research system experimentation, as either a screening objective for a candidate or as a detailed study objective for a candidate.

In embodiments where a screening objective is identified, a goal of the high throughput research system experimentation is to produce a pass/fail, or a yes/no, result from the candidates that are processed by the high throughput research system. When the screening objective is identified then the method 300 can include developing a screening design for a candidate, as shown at block 332.

In embodiments where the screening objective is identified and developing a screening design is included, then each level, such as varying concentrations, or combinations, such as combinations of substances, can be considered to be a candidate experiment. The candidates, or the candidate experiments, can be applied across a high throughput plate or plates, processed by the high throughput research system, and compared to one another or to a predetermined target. As discussed herein, determination of acceptable variation, or an acceptable signal-to-noise ratio, can be included in developing the screening design to help provide that the workflow process produces statistically defensible data.

The various embodiments can also include developing false negative and/or false positive rates when a screening objective is identified. Developing false negative and/or false positive rates can be included in developing the screening design. The false negative and/or false positive rates can be used to increase the confidence of decisions which pertain to the high throughput research system. As understood by one of ordinary skill in the art, false negatives are lost opportunities from candidates whose effects are missed and false positives are erroneous opportunities from candidates whose effects appear more significant than they truly are. As a non-limiting example, false negative and false positive probabilities can be calculated using a distribution centered at the decision limit. The false probability is then calculated as the area in the tail of the distribution which is beyond observed response.

The various embodiments also can include calculating a required sample size when a screening objective is identified. As is appreciated, known and appropriate statistical methodologies can be employed when calculating a required sample size.

Embodiments of the present disclosure can also include determining a number of replications when a screening objective is identified. Determining the number of replications can help minimize false negative and/or false positive rates, as well as help to reduce the uncertainty of observation averages. As will be appreciated by one skilled in the art, the standard deviation of the average of an observation will be decreased by a factor equal to the square root of the number of observations. The number of observations can be determined based on acceptable false positive and false negative rates along with consideration of economic and experimental factors related to the high throughput research system.

In some embodiments, the objective of high throughput research system experimentation can be a detailed study objective. The detailed study objective can be identified when a goal of the high throughput study is other than to produce a pass/fail, or yes/no, result from a candidate that is processed by the high throughput research system.

Embodiments of the present disclosure can include determining if there are any restrictions in randomization associated with the workflow, as shown in block 336. Restrictions in randomization can occur when it is not feasible and/or possible to completely randomize experimental variables. For example, in some high throughput research system applications it may be unfeasible or impossible to randomize temperature and/or pressure, thus resulting in restrictions in randomization. As will be appreciated by one having ordinary skill in the art, restrictions in randomization may be determined via known and appropriate methodologies.

For the various embodiments, a design of experiment, or DOE, can be developed following the determination of restrictions in randomization. The method 300, as discussed herein, can include a classical design of experiment that has been developed for a candidate, as shown at block 338, or a split-plot design of experiment that has been developed for a candidate, as shown at block 340.

In embodiments where there are no restrictions in randomization, the method 300 can include a classical design of experiment, where all of the terms in the statistical model are tested against one error term. Embodiments of the present disclosure can include developing false negative and/or false positive rates, as discussed herein, when a classical design of experiment is developed. Embodiments of the present disclosure can also include determining a number of replications, as discussed herein, when a classical design of experiment is developed.

In embodiments where there are restrictions in randomization, the method 300 can include a split-plot design of experiment, shown at block 340, where more than one error term is used and the terms in the experimental model are tested against a specific error term.

Embodiments of the present disclosure can include developing false negative and/or false positive rates, as discussed herein, when a split-plot design of experiment is developed. Embodiments of the present disclosure can also include determining a number of replications, as discussed herein, when a split-plot design of experiment is developed.

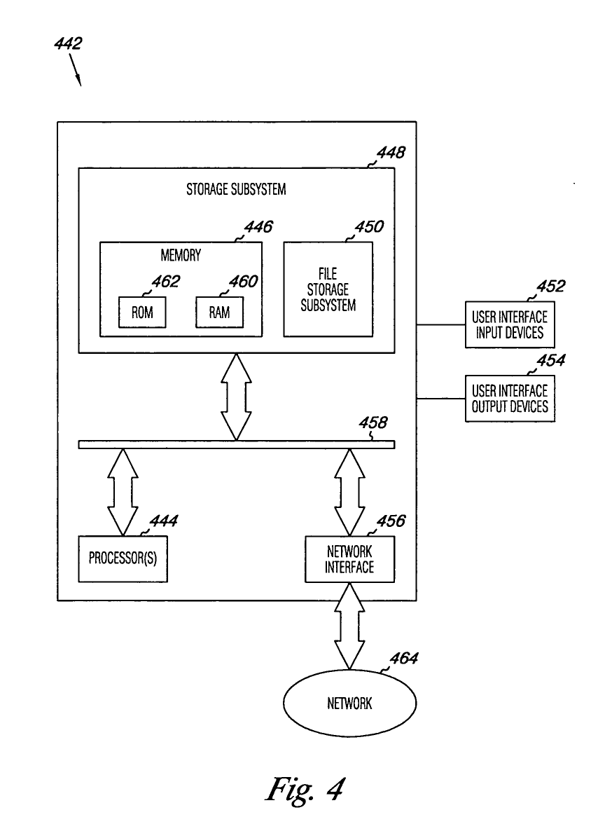

FIG. 4 illustrates a computer system 442 that includes a computer readable medium and a computing device suitable to implement a method, in accordance with embodiments of the present disclosure. Embodiments of the present disclosure are directed to computer readable mediums and/or computing devices.

Embodiments of the present disclosure include a computing device which includes at least one processor 444 and a memory 446 which are in communication. Embodiments also include a processor 444 that communicates with a number of other components, which can include a storage subsystem 448 having a memory 446 and a file storage subsystem 450, a configurable user interface input device 452 having a display, a configurable user interface output device 454 having a display, a network interface 456, and a communication bus 458. Embodiments described herein can be implemented in a distributed computing network environment and, as will be appreciated by one of ordinary skill in the art, the embodiments are not limited to the descriptions given herein.

The input and output devices 452, 454 can allow user interaction with the system 442, for instance to provide for data entry or data retrieval. The storage subsystem 448 and/or a memory 446 can be included, as depicted by computer system 442, or be in communication with known computing components to enable the device to perform various functions, tasks, or roles, including steps of the method disclosed herein. For example, computer executable instructions can be stored in the memory 446, where the stored instructions are executable by the processor 444 to perform a variance component analysis, identify a design objective, provide an experimental design, block known variation, randomize unknown variation, address restrictions in randomization when present, and provide at least one of a screening design, a split plot design, or a classical design of experiment.

The memory 446 can also include a subsystem that can include programs, code, data, look-up tables, etc. The memory 446 can in communication with the processor 444. A file storage subsystem 450 can provide storage for additional program and data files, and may include a hard disk drive, a floppy disk drive along with associated removable media, a compact digital read only memory (CD-ROM) drive, an optical drive, or removable media cartridges. The memory 446 can include a number of memories, including a main random access memory (RAM) 460 for storage of program instructions and data during program execution and a read only memory (ROM) 462 in which fixed instructions can be stored. Data can be stored in a data base that stores high throughput experimental data and statistical analysis can be performed on the data.

The storage subsystem 450 can provide various computer readable medium. Embodiments of the present disclosure can include computer readable medium having instructions stored thereon for causing a computing device to perform steps of the method disclosed herein. For example, the computing device can be caused to perform steps that can include quantifying systematic variation in a high throughput research system that is to process a candidate, identifying a design objective for the candidate, and providing an experimental design for the candidate that accounts for the systematic variation to produce the statistically defensible results. Embodiments of the present disclosure can include computer readable medium having instructions stored thereon for causing a computing device to perform the method further including providing an experimental design for the candidate that accounts for randomization restrictions. As used herein, a computer readable medium is intended to include the types of memory described above. Program embodiments can be included with the computer readable medium and may also be provided over a communications network such as the Internet, wireless RF networks, or other suitable network 464.

This disclosure is intended to cover adaptations or variations of various embodiments. It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the disclosure includes other applications in which the above structures and methods are used.

### EXAMPLES

The following examples are provided to illustrate various aspects of the present disclosure, but not to limit the scope of the disclosure in any way.

### Example 1

### Sample to Sample Systemic Variation Study, Trial 1

A uniform formulation is distributed to each of fifty four (54) cells within a plate. Each cell receives a fixed amount of mass by hand pipetting and the mass of the samples is determined. The samples are cured by being placed in an oven at room temperature, heated to a fixed temperature for a certain amount of time, and held for a fixed time period. The samples are reweighed to obtain “post-cure” masses. The samples are then placed in a second oven, reheated, and held for another fixed time period. The samples are then cooled and reweighed to determine the “post-burn mass.” The percentages of the initial masses remaining and the corresponding plate number and cell location are shown in Table 1.

TABLE 1

| Cell | Mass Remaining | Column | Plate |
|---|---|---|---|
| A1 | | A | 1 |
| A2 | 66.05 | A | 1 |
| A3 | 60.35 | A | 1 |
| A4 | 58.03 | A | 1 |
| A5 | | A | 1 |
| A6 | 56.98 | A | 1 |
| B1 | 60.9 | B | 1 |
| B2 | | B | 1 |
| B3 | 36.66 | B | 1 |
| B4 | 34.11 | B | 1 |
| B5 | 69.67 | B | 1 |
| B6 | 45.83 | B | 1 |
| C1 | 63.41 | C | 1 |
| C2 | 50.43 | C | 1 |
| C3 | | C | 1 |
| C4 | 46.22 | C | 1 |
| C5 | 43.42 | C | 1 |
| C6 | 36.93 | C | 1 |
| D1 | | D | 1 |
| D2 | 39 | D | 1 |
| D3 | 63.85 | D | 1 |
| D4 | 34.8 | D | 1 |
| D5 | 51.34 | D | 1 |
| D6 | 56.85 | D | 1 |
| E1 | 37.85 | E | 1 |
| E2 | 43 | E | 1 |
| E3 | 39.31 | E | 1 |
| E4 | 62.22 | E | 1 |
| E5 | 46.25 | E | 1 |
| E6 | 46.11 | E | 1 |
| F1 | 27.92 | F | 1 |
| F2 | | F | 1 |
| F3 | | F | 1 |
| F4 | 32.61 | F | 1 |
| F5 | | F | 1 |
| F6 | 38.09 | F | 1 |
| G1 | 50.52 | G | 1 |
| G2 | 56.57 | G | 1 |
| G3 | 65.3 | G | 1 |
| G4 | | G | 1 |
| G5 | | G | 1 |
| G6 | 42.43 | G | 1 |
| H1 | 46.92 | H | 1 |
| H2 | 59.63 | H | 1 |
| H3 | 45.78 | H | 1 |
| H4 | 62.94 | H | 1 |
| H5 | 48.63 | H | 1 |
| H6 | 47.67 | H | 1 |
| I1 | | I | 1 |
| I2 | 60.6 | I | 1 |
| I3 | 57.43 | I | 1 |
| I4 | | I | 1 |
| I5 | 55.2 | I | 1 |
| I6 | 38.87 | I | 1 |
| A1 | 40.73 | A | 2 |
| A2 | 47.31 | A | 2 |
| A3 | 47.34 | A | 2 |
| A4 | 78.61 | A | 2 |
| A5 | 50.58 | A | 2 |
| A6 | 50.73 | A | 2 |
| B1 | 41.07 | B | 2 |
| B2 | 44.18 | B | 2 |
| B3 | 65.12 | B | 2 |
| B4 | 71 | B | 2 |
| B5 | 41.32 | B | 2 |
| B6 | 65.95 | B | 2 |
| C1 | 41.02 | C | 2 |
| C2 | 48.26 | C | 2 |
| C3 | 51.03 | C | 2 |
| C4 | 82.12 | C | 2 |
| C5 | 54.13 | C | 2 |
| C6 | 66.85 | C | 2 |
| D1 | 60.08 | D | 2 |
| D2 | 61.89 | D | 2 |
| D3 | 38.79 | D | 2 |
| D4 | 70.52 | D | 2 |
| D5 | 47.57 | D | 2 |
| D6 | | D | 2 |
| E1 | 56.44 | E | 2 |
| E2 | 56.55 | E | 2 |
| E3 | 45.09 | E | 2 |
| E4 | 39.01 | E | 2 |
| E5 | 53.37 | E | 2 |
| E6 | 56.74 | E | 2 |
| F1 | 84.11 | F | 2 |
| F2 | 78.93 | F | 2 |
| F3 | 57.35 | F | 2 |
| F4 | 76 | F | 2 |
| F5 | 55.89 | F | 2 |
| F6 | 65.1 | F | 2 |
| G1 | 48.23 | G | 2 |
| G2 | 43.41 | G | 2 |
| G3 | | G | 2 |
| G4 | 61.75 | G | 2 |
| G5 | 66.03 | G | 2 |
| G6 | | G | 2 |
| H1 | 59.07 | H | 2 |
| H2 | 44.92 | H | 2 |
| H3 | 62.04 | H | 2 |
| H4 | 46.45 | H | 2 |
| H5 | | H | 2 |
| H6 | | H | 2 |
| I1 | 47.45 | I | 2 |
| I2 | 39.4 | I | 2 |
| I3 | 48.46 | I | 2 |
| I4 | 41.13 | I | 2 |
| I5 | 49.35 | I | 2 |
| I6 | 69 | I | 2 |

The generated data from Table 1 is evaluated using JMP® software (available from SAS Institute, Cary, N.C.) at a 95 percent confidence level. The evaluated data is shown in Table 2, where

TABLE 2

| | Degrees of | Sum of | Mean | | |
|---|---|---|---|---|---|
| Source | Freedom | Squares | Square | F Ratio | P Value |
| Plate | 1 | 822.99 | 822.99 | 6.80 | 0.01 |
| Column[plate] | 16 | 3191.29 | 199.46 | 1.65 | 0.08 |
| (columns nested | | | | | |
| within plates) | | | | | |
| Error | 71 | 8598.81 | 121.11 | 0.03 | |
| C. Total | 88 | 12539.67 | | | |

The Analysis of Variance Method is used in JMP® to estimate the variance components. The variance component expression is

σ²ₜ=σ²_{Plates}+σ²_{Columns}+σ²_{Within}.

where

σ²ₜ is the total variability in % sample retained, including variability due to the different plates, variability due to the different columns, and variability due to the rows in each column;

σ²_{Plates} is the variance component for the plates;

σ²_{Columns} is the variance components for the columns; and

σ²_{Within} reflects the variance observed when different rows are measured in the same column.

Variance components are shown in Table 3. The term Sqrt (Var. Component) is the positive square root of the variance component which is also equal to the standard deviation.

TABLE 3
Variance Components

| | Var. | % of | Sqrt (Var. |
|---|---|---|---|
| Component | Component (σ²) | Total | Component) |
| Plate | 13.14 | 8.8 | 3.624 |
| Column[Plate] | 14.39 | 9.6 | 3.793 |
| (columns nested | | | |
| within plates) | | | |
| Within | 122.57 | 81.7 | 11.071 |
| Total | 150.09 | 100.0 | 12.251 |

The mean percentage sample retained is 50.62 percent, meaning that the measurements of percentage sample retained are expected to be within 50.62 percent (+/−3σ). The observed range of 36.75 percent retained is determined to be too large, with most of the variation being due to the rows in the different columns.

Sample to Sample Systemic Variation Study, Trial 2:

Modifications to the workflow are made, including using a plate that allows less lateral movement than the plate used in Trial 1, using more consistent sample sizes than those used in Trial 1, and using a higher cure temperature than the one used in Trial 1. Otherwise, procedure for Trial 2 is consistent with procedure for Trial 1. The percentages of the initial masses remaining and the corresponding plate number and cell location are shown in Table 4.

TABLE 4

| Cell | Mass Remaining | Column | Plate |
|---|---|---|---|
| A1 | 55.58 | A | 2 |
| A2 | 55.25 | A | 2 |
| A3 | 55.52 | A | 2 |
| A4 | 55.15 | A | 2 |
| A5 | 55.8 | A | 2 |
| A6 | 55.56 | A | 2 |
| B1 | 55.36 | B | 2 |
| B2 | 55.7 | B | 2 |
| B3 | 55.24 | B | 2 |
| B4 | 55.54 | B | 2 |
| B5 | 55.61 | B | 2 |
| B6 | 55.74 | B | 2 |
| C1 | 55.48 | C | 2 |
| C2 | 56.57 | C | 2 |
| C3 | 55.83 | C | 2 |
| C4 | 55.53 | C | 2 |
| C5 | 55.74 | C | 2 |
| C6 | 55.81 | C | 2 |
| D1 | 55.5 | D | 2 |
| D2 | 55.4 | D | 2 |
| D3 | 55.41 | D | 2 |
| D4 | 56.41 | D | 2 |
| D5 | 54.67 | D | 2 |
| D6 | 55.86 | D | 2 |
| E1 | 55.12 | E | 2 |
| E2 | 55.17 | E | 2 |
| E3 | 55.83 | E | 2 |
| E4 | 55.53 | E | 2 |
| E5 | 55.83 | E | 2 |
| E6 | 55.52 | E | 2 |
| F1 | 55.6 | F | 2 |
| F2 | 55.28 | F | 2 |
| F3 | 55.38 | F | 2 |
| F4 | 55.49 | F | 2 |
| F5 | 54.71 | F | 2 |
| F6 | 56.14 | F | 2 |
| G1 | 55.35 | G | 2 |
| G2 | 55.42 | G | 2 |
| G3 | 55.91 | G | 2 |
| G4 | 55.39 | G | 2 |
| G5 | | G | 2 |
| G6 | 55.45 | G | 2 |
| H1 | 54.75 | H | 2 |
| H2 | 55.64 | H | 2 |
| H3 | 55.23 | H | 2 |
| H4 | 55.64 | H | 2 |
| H5 | 55.23 | H | 2 |
| H6 | 55.85 | H | 2 |
| I1 | 55.28 | I | 2 |
| I2 | 55.37 | I | 2 |
| I3 | 55.57 | I | 2 |
| I4 | 55.25 | I | 2 |
| I5 | 55.99 | I | 2 |
| I6 | | I | 2 |
| A1 | 56.35 | A | 1 |
| A2 | 56.23 | A | 1 |
| A3 | 56.25 | A | 1 |
| A4 | 56.34 | A | 1 |
| A5 | 56.41 | A | 1 |
| A6 | 56.61 | A | 1 |
| B1 | 56.04 | B | 1 |
| B2 | 56.48 | B | 1 |
| B3 | 56.04 | B | 1 |
| B4 | 56.31 | B | 1 |
| B5 | 56.33 | B | 1 |
| B6 | 56.55 | B | 1 |
| C1 | 56.16 | C | 1 |
| C2 | 56.36 | C | 1 |
| C3 | 56.36 | C | 1 |
| C4 | 56.24 | C | 1 |
| C5 | 56.27 | C | 1 |
| C6 | 56.36 | C | 1 |
| D1 | 55.97 | D | 1 |
| D2 | 56.01 | D | 1 |
| D3 | 56.19 | D | 1 |
| D4 | 56.06 | D | 1 |
| D5 | 56.14 | D | 1 |
| D6 | 56.36 | D | 1 |
| E1 | 55.94 | E | 1 |
| E2 | 55.58 | E | 1 |
| E3 | 56.26 | E | 1 |
| E4 | 56.09 | E | 1 |
| E5 | 56.4 | E | 1 |
| E6 | 56.32 | E | 1 |
| F1 | 56.07 | F | 1 |
| F2 | 56.29 | F | 1 |
| F3 | 56.5 | F | 1 |
| F4 | 56.53 | F | 1 |
| F5 | 56.29 | F | 1 |
| F6 | 56.82 | F | 1 |
| G1 | 56.29 | G | 1 |
| G2 | 56.23 | G | 1 |
| G3 | 56.71 | G | 1 |
| G4 | 56.5 | G | 1 |
| G5 | 56.23 | G | 1 |
| G6 | 56.5 | G | 1 |
| H1 | 56.38 | H | 1 |
| H2 | 56.52 | H | 1 |
| H3 | 56.47 | H | 1 |
| H4 | 56.61 | H | 1 |
| H5 | 56.66 | H | 1 |
| H6 | 56.72 | H | 1 |
| I1 | 56.56 | I | 1 |
| I2 | 56.44 | I | 1 |
| I3 | 56.08 | I | 1 |
| I4 | 56.66 | I | 1 |
| I5 | 55.78 | I | 1 |
| I6 | 57.02 | I | 1 |

The statistical analysis of Trial 1 is repeated for Trial 2, and results are shown in Tables 5 and 6.

TABLE 5

| | Degrees of | Sum of | Mean | | |
|---|---|---|---|---|---|
| Source | Freedom | Squares | Square | F Ratio | P Value |
| Plate | 1 | 17.29 | 17.29 | 183.02 | 3.285e−23 |
| Column[plate] | 16 | 1.79 | 0.11 | 1.19 | 0.2949 |
| (columns nested | | | | | |
| within plates) | | | | | |
| Error | 88 | 8.31 | 0.094 | 0.03 | |
| C. Total | 105 | 27.41 | | | |

TABLE 6
Variance Components

| | Var. | % of | Sqrt (Var. |
|---|---|---|---|
| Component | Component (σ²) | Total | Component) |
| Plate | 0.32 | 76.90 | 0.57 |
| Column[Plate] | 0.003 | 0.77 | 0.06 |
| (columns nested | | | |
| within plates) | | | |
| Within | 0.09 | 22.32 | 0.31 |
| Total | 0.42 | 100.00 | 0.65 |

The Trial 2 mean percent of initial sample remaining is 56.33 percent, and measures are expected to be within 56.33 percent+/−1.95 percent, which is acceptable variation. The range of residual sample masses is significantly reduced from Trial 1 to Trial 2, indicating the improvement steps implemented after Trial 1 are effective.

Plate-To-Plate Reproducibility Study:

Fifty-four cells are pre-loaded onto two separate holders. Tare weights are determined for cells on Plate 1 and Plate 2 and each cell receives a fixed amount of a compound. The samples are treated as in the Sample-to-Sample Study by being cured at a fixed temperature, reweighed, and then thermally degraded. Results from Plate 1 and Plate 2 are compared to show a statistically significant difference, of 0.8 percent, in the mean percentage of initial sample remaining. The JMP® equivalence test is used to test practical significance by selecting a threshold difference for which smaller differences are practically equivalence. The threshold level for percent initial sample remaining is set at 1 percent, or in other words samples that differ in percent sample remaining less than 1 percent are considered equivalent. The actual difference is 0.808 percent, and the test shows a p-value of 0.001. Therefore, the difference of 0.808 percent is declared zero for practical purposes where the threshold level of 1 percent is specified as satisfactory, and the variation is considered acceptable.

A goal of the experimental study is to perform a detailed study regarding multiple types and concentrations of compounds. The detailed study includes four type I compounds, nine type II compounds, and three type II concentrations: 0.5, 1.0 and 2.0 weight percent in the final type I/type II mixtures, corresponding respectively to low, mid, and high in Tables 7, 8, 9, and 10.

A multifactor experiment is performed in plates of fifty-four cells each. Complete randomization of the order of experiments is not possible; therefore an entire section (column or row) has the same combination of type I compound and type II compound concentration. Because all experimental runs cannot be completely randomized, a split-plot design is provided for the candidates. Different plates have different patterns of sample placement, as provided by the DOE, which are respectively shown in Tables 7, 8, 9, and 10. The symbol “T” indicates that samples contain the highest type II compound concentration and the symbol “1” indicates that samples contain the lowest type II compound concentration. Type II compounds marked 10, 11, and 12 correspond to control cells and have a type II compound concentration of zero.

TABLE 7

| | | Plate 1 Columns | | | | | | | | |
|---|---|---|---|---|---|---|---|---|---|---|
| | | A | B | C | D | E | F | G | H | I |
| Plate 1 Rows | 6 | 1↑ | 6↓ | 6 | 1 | 6↑ | 6 | 1 | 1↓ | 1↑ |
| | 5 | 2↑ | 11 | 11 | 2 | 11 | 11 | 2 | 2↓ | 2↑ |
| | 4 | 3↑ | 7↓ | 7 | 3 | 7↑ | 7 | 3 | 3↓ | 3↑ |
| | 3 | 10 | 8↓ | 8 | 10 | 8↑ | 8 | 10 | 10 | 10 |
| | 2 | 4↑ | 9↓ | 9 | 4 | 9↑ | 9 | 4 | 4↓ | 4↑ |
| | 1 | 5↑ | 12 | 12 | 5 | 12 | 12 | 5 | 5↓ | 5↑ |
| | | Type IA | Type IB | Type IA | Type IB | Type IA | Type IB | Type IA | Type IB | Type IA |
| | | High | Low | Mid | Mid | High | Mid | Mid | Low | High |

TABLE 8

| | | Plate 2 Columns | | | | | | | | |
|---|---|---|---|---|---|---|---|---|---|---|
| | | A | B | C | D | E | F | G | H | I |
| e2 | 6 | 6 | 1↑ | 1 | 6↓ | 6 | 1↓ | 6↑ | 6↓ | 1 |
| | 5 | 11 | 2↑ | 2 | 11 | 11 | 2↓ | 11 | 11 | 2 |
| | 4 | 7 | 3↑ | 3 | 7↓ | 7 | 3↓ | 7↑ | 7↓ | 3 |
| | 3 | 8 | 10 | 10 | 8↓ | 8 | 10 | 8↑ | 8↓ | 10 |
| | 2 | 9 | 4↑ | 4 | 9↓ | 9 | 4↓ | 9↑ | 9↓ | 4 |
| | 1 | 12 | 5↑ | 5 | 12 | 12 | 5↓ | 12 | 12 | 5 |
| | | Type IB | Type IC | Type IC | Type IC | Type IC | Type IC | Type IC | Type IC | Type IB |
| | | Mid | High | Mid | Low | Mid | Low | High | Low | Mid |

TABLE 9

| | | Plate 3 Columns | | | | | | | | |
|---|---|---|---|---|---|---|---|---|---|---|
| | | A | B | C | D | E | F | G | H | I |
| Plate 3 Rows | 6 | 1↓ | 6 | 1↑ | 6 | 1↑ | 1 | 6↑ | 1 | 6↓ |
| | 5 | 2↓ | 11 | 2↑ | 11 | 2↑ | 2 | 11 | 2 | 11 |
| | 4 | 3↓ | 7 | 3↑ | 7 | 3↑ | 3 | 7↑ | 3 | 7↓ |
| | 3 | 10 | 8 | 10 | 8 | 10 | 10 | 8↑ | 10 | 8↓ |
| | 2 | 4↓ | 9 | 4↑ | 9 | 4↑ | 4 | 9↑ | 4 | 9↓ |
| | 1 | 5↓ | 12 | 5↑ | 12 | 5↑ | 5 | 12 | 5 | 12 |
| | | Type ID | Type IC | Type ID | Type ID | Type ID | Type ID | Type ID | Type IC | Type ID |
| | | Low | Mid | High | Mid | High | Mid | High | Mid | Low |

TABLE 10

| | | Plate 4 Columns | | | | | | | | |
|---|---|---|---|---|---|---|---|---|---|---|
| | | A | B | C | D | E | F | G | H | I |
| Plate 4 Rows | 6 | 6 | 1↓ | 6↑ | 1↑ | 1 | 6 | 1↑ | 6↓ | 1 |
| | 5 | 11 | 2↓ | 11 | 2↑ | 2 | 11 | 2↑ | 11 | 2 |
| | 4 | 7 | 3↓ | 7↑ | 3↑ | 3 | 7 | 3↑ | 7↓ | 3 |
| | 3 | 8 | 10 | 8↑ | 10 | 10 | 8 | 10 | 8↓ | 10 |
| | 2 | 9 | 4↓ | 9↑ | 4↑ | 4 | 9 | 4↑ | 9↓ | 4 |
| | 1 | 12 | 5↓ | 12 | 5↑ | 5 | 12 | 5↑ | 12 | 5 |
| | | Type ID | Type IA | Type IB | Type IB | Type IA | Type IA | Type IB | Type IA | Type ID |
| | | Mid | Low | High | High | Mid | Mid | High | Low | Mid |

Vials are loaded with an appropriate basis of type I compound. A fixed amount of a type II compound is added to each vial to yield a final solution concentration as provided by the design of experiment (DOE). After the basis of type I compounds and the type II compounds are combined the vials are sealed and well mixed. A hand pipetter is used to withdraw a fixed amount of blended solution from each vial, and the fixed amount is transferred to the appropriate cell in the 54 cell array.

After the samples are added to the cells, the cell masses are determined. For curing, the samples are placed in an oven at room temperature, heated to a fixed temperature over a fixed period of time, and held isothermally for a fixed period of time. The post-cure mass of the samples is determined and the samples are placed into another oven, which is pre-heated to a fixed temperature for a fixed period of time. The array is removed and allowed to cool. The post-burn masses of the samples are determined.

Plates 2, 3, and 4 are prepared in triplicate so that data from each of the plates is averaged to yield a single composite data set with a mean and a standard deviation for each sample. Experiments at the same experimental conditions in the same plate are considered duplicates, and experiments at the same experimental conditions in different plates are considered replicates. Data generated from the runs is used as input data for JMP® calculations.

The described split-plot design structure allows for independent estimates of the individual and interactive effects of the four input variables. It is possible to fit a statistical model as shown in Equation 1.

y=βₒ+Rᵢ+Aⱼ+Cₖ+(RA)ᵢⱼ+(RC)ᵢₖ+(AC)ⱼₖ+ε₁+ε₂ Equation 1. Fit For Statistical Model

where

y is the % sample remaining;

βₒ is the model intercept;

R is the type I compound (i=1, 2, 3, 4 for the four type I compounds);

A is the type II compound (j=1, 2, 3, 4, 5, 6, 7, 8, 9 for the nine type II compounds);

C is type II compound concentration (k=1, 2, 3 for the three type II compound concentrations);

(RA) is the interaction of type I compound and type II compound;

(RC) is the interaction between the type I compound and type II compound concentration;

(AC) is the interaction between type II compound and type II compound concentration;

ε₁ is the error associated with not being able to completely randomize the experiments (type I compound and type II compound concentration occurred in columns or rows); and

ε₂ is the experimental error (other variation that occurs during experimentation).

Fitting the split-plot models using Equation 1 results in a R² of 0.97, that indicates 97 percent of the variability in the response is explained by the model. Table 11 shows the effect tests for the model considered in Equation 1 and analyses are performed in JMP® at the 95 percent confidence, where

Nparm is the number of parameters associated with the effect. Continuous effects have one parameter. Nominal effects have one less parameter than the number of levels. Crossed effects multiply the number of parameters for each term. Nested effects depend on how levels occur;

DF is the degrees of freedom for the effect test;

DFDen the degrees of freedom used in the denominator for each test;

F Ratio is the F-statistic for testing that the effect is zero. The F Ratio is the ratio of the mean square for the effect divided by the mean square for error. The mean square for the effect is the sum of squares for the effect divided by its degrees of freedom.

Prob>F is the significance probability for the F-ratio. It is the probability that if the null hypothesis is true, a larger F-statistic would only occur due to random error.

TABLE 11

| Source | Nparm | DF | DFDen | F Ratio | Prob > F |
|---|---|---|---|---|---|
| Type I compound | 3 | 3 | 8 | 96.6991 | <0.0001 |
| Type II compound | 8 | 8 | 88 | 7.2078 | <0.0001 |
| Type II compound | 1 | 1 | 8 | 0.2489 | 0.6313 |
| Concentration | | | | | |
| Type I compound * | 24 | 24 | 88 | 4.8896 | <0.0001 |
| Type II compound | | | | | |
| Type I compound * | 3 | 3 | 8 | 0.3108 | 0.8173 |
| Type II compound | | | | | |
| Concentration | | | | | |
| Type II compound * | 8 | 8 | 88 | 1.3765 | 0.2179 |
| Type II compound | | | | | |
| Concentration | | | | | |

Terms that are significant at 95 percent are those for which (prob>|t| in tables was less than <0.05). Significant effects are those of type I compound, type II compound, and the interaction between type I compound and type II compound.

The execution of the pre-design phase which includes identifying systematic sources of variation, investigating the causes, and modifying the workflow process until variation is at an acceptable level, allows 95 percent reduction in variation from 12.251 units (see table 3) to 0.65 units (see table 6). If the pre-design phase had not been executed, the data would reflect a large variability which would not allow real signals to be detected. Table 12 shows the effect tests under this circumstance.

TABLE 12

| Source | Nparm | DF | DFDen | F Ratio | Prob > F |
|---|---|---|---|---|---|
| Type I compound | 3 | 3 | 8 | 5.2270 | 0.0274 |
| Type II compound | 8 | 8 | 88 | 0.3896 | 0.9235 |
| Type II compound | 1 | 1 | 8 | 0.0135 | 0.9105 |
| Concentration | | | | | |
| Type I compound * | 24 | 24 | 88 | 0.2643 | 0.9998 |
| Type II compound | | | | | |
| Type I compound * | 3 | 3 | 8 | 0.0168 | 0.9968 |
| Type II compound | | | | | |
| Concentration | | | | | |
| Type II compound * | 8 | 8 | 88 | 0.0744 | 0.9997 |
| Type II compound | | | | | |
| Concentration | | | | | |

In this case, only the type I compound becomes significant and there is an increased possibility of missing the effects of type II compound and the effects of the interaction between type I compound and type II compound (see table 11).

Additionally, if the restrictions in randomization are not addressed in the design-phase, the analysis results are different. Table 13 shows the effect tests when the pre-design phase is not executed and the restrictions in randomization are not addressed.

TABLE 13

| Source | Nparm | DF | F Ratio | Prob > F |
|---|---|---|---|---|
| Type I compound | 3 | 3 | 31.24561 | 0.0000 |
| Type II compound | 8 | 8 | 0.213303 | 0.9879 |
| Type II compound Concentration | 1 | 1 | 0.080432 | 0.7773 |
| Type I compound*Type II compound | 24 | 24 | 0.144697 | 1.0000 |
| Type I compound * Type II compound Concentration | 3 | 3 | 0.100416 | 0.9596 |
| Type II compound * Type II compound Concentration | 8 | 8 | 0.040735 | 1.0000 |

In this case, the F Ratio and Prob>F are different from those obtained when the method described herein is followed, as shown in table 11. In this case, only type I compound becomes significant, and there is an increased possibility of missing the effects of type II compound, and the effects of the interaction between type I compound and type II compound (see table 11).

This example illustrates the importance of following the method described herein to provide a workflow process which can produce statistically defensible data and enable reliable research to be conducted utilizing high throughput research systems.

### Example 2

This example pertains to the screening of different compounds via a high throughput research system.

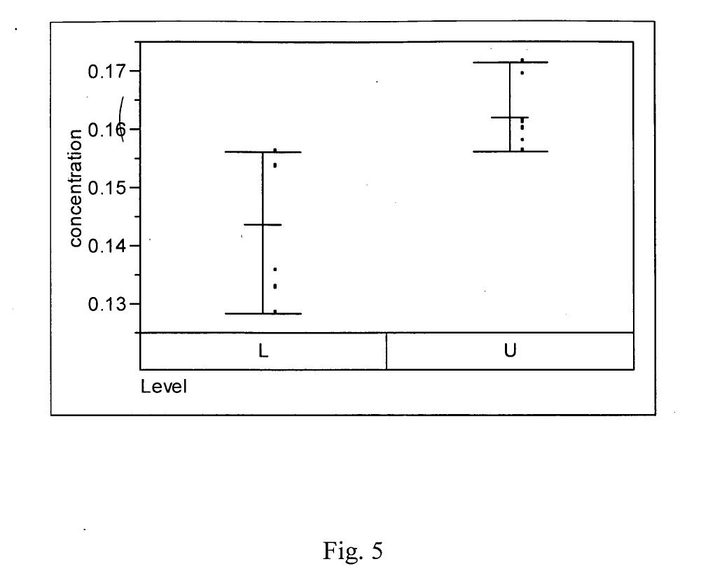

Experiments organized in rows and columns are conducted in a high throughput research system. A variance component analysis is performed measuring concentration using the same amount of compound and same pressure. This analysis reveals systematic variation where the upper rows (U) provide a different mean concentration than the lower rows (L). The differing mean concentrations are shown in FIG. 5, and statistical analysis is provided in Tables 14 and 15. FIG. 5 is a graph of the different concentrations between the levels where U=concentrations in rows A to D, and L=concentrations in rows E to H.

TABLE 14

| | Degrees of | Sum of | | | |
|---|---|---|---|---|---|
| Source | Freedom | Squares | Mean Square | F Ratio | Prob > F |
| Level | 1 | 0.00137 | 0.00137 | 15.4022 | 0.0015 |
| Within | 14 | 0.001245 | 8.89e−5 | | |
| Total | 15 | 0.002614 | 0.00017 | | |

TABLE 15

| | Var. | % of | Sqrt (Var. |
|---|---|---|---|
| Component | Component | Total | Component) |
| Level | 0.00016008 | 64.3 | 0.01265 |
| Within | 0.00008892 | 35.7 | 0.00943 |
| Total | 0.00024900 | 100.0 | 0.01578 |

The difference between the upper and lower rows is believed to be associated with the equipment configuration and is therefore considered unavoidable. In this case unavoidable variation is to be blocked when experimenting in this high throughput research system.

The unavoidable variation is addressed through blocking and assignment of candidates to a plate location with consideration of the known “level” source of unavoidable variation.

Twelve candidates can be simultaneously screened for differences using the high throughput research system using a plate having 48 cells. The twelve identical, but unknown, candidates are assigned to the 48 cells of the plate as shown in Table 16. The assignment of the candidates, as shown in Table 16, may be convenient but the assignment fails to address the level source of unavoidable variation.

TABLE 16

| | C1 | C2 | C3 | C4 | C5 | C6 |
|---|---|---|---|---|---|---|
| A | 1 | 3 | 5 | 7 | 9 | 11 |
| B | 1 | 3 | 5 | 7 | 9 | 11 |
| C | 1 | 3 | 5 | 7 | 9 | 11 |
| D | 1 | 3 | 5 | 7 | 9 | 11 |
| E | 2 | 4 | 6 | 8 | 10 | 12 |
| F | 2 | 4 | 6 | 8 | 10 | 12 |
| G | 2 | 4 | 6 | 8 | 10 | 12 |
| H | 2 | 4 | 6 | 8 | 10 | 12 |

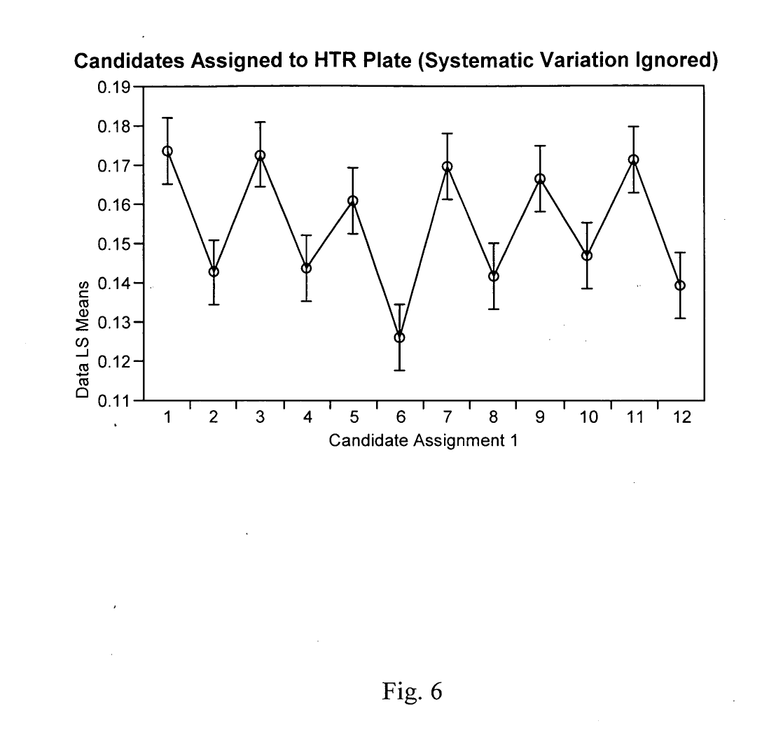

As shown in Table 16, candidates 1, 3, 5, 7, 9, and 11 are assigned to the “upper” rows of the plate being A, B, C, and D. Candidates 2, 4, 6, 8, 10, and 12 are assigned to the “lower” rows of the plate being E, F, G, and H. The upper rows of the plate and the lower rows of the plate represent different levels. Because of the assignment shown in Table 16 apparent, but untrue, differences between the candidates are likely to be detected due to the fact that the assignment of the candidates, as shown in Table 16, has not addressed the unavoidable variation between the levels. Data is provided in FIG. 6.

As shown in FIG. 6, there are apparent differences between the identical candidates when the level source of unavoidable variation is not addressed. FIG. 6 illustrates that differences between the identical candidates are potentially falsely identified. The falsely identified differences, as shown in FIG. 6, are solely due to the “level” variability and are not due to experimentally sought after differences between the candidates themselves.

The unavoidable variation can be addressed by assigning the twelve identical candidates to the 48 cells of the plate, as shown in Table 17.

TABLE 17

| | C1 | C2 | C3 | C4 | C5 | C6 |
|---|---|---|---|---|---|---|
| A | 12 | 6 | 8 | 7 | 4 | 1 |
| B | 3 | 1 | 10 | 9 | 12 | 5 |
| C | 11 | 5 | 7 | 8 | 3 | 2 |
| D | 1 | 2 | 9 | 10 | 11 | 6 |
| E | 10 | 11 | 6 | 4 | 2 | 9 |
| F | 8 | 3 | 1 | 11 | 5 | 7 |
| G | 9 | 12 | 5 | 3 | 1 | 10 |
| H | 7 | 4 | 2 | 12 | 6 | 8 |

The assignment of the twelve identical candidates, as shown in Table 17, addresses the unavoidable variation that is due to the different levels of the plate. The assignment of the twelve identical candidates to the 48 cell positions on the plate, as shown in Table 17, provides that the twelve identical candidates are equally represented in the “upper” rows as well as the “lower” rows, in contrast to the assignment of candidates as shown in Table 16. The assignment, as shown in Table 17, provides that an unbiased assessment of differences between the candidates can be performed because of addressing the unavoidable variation due to the plate levels.

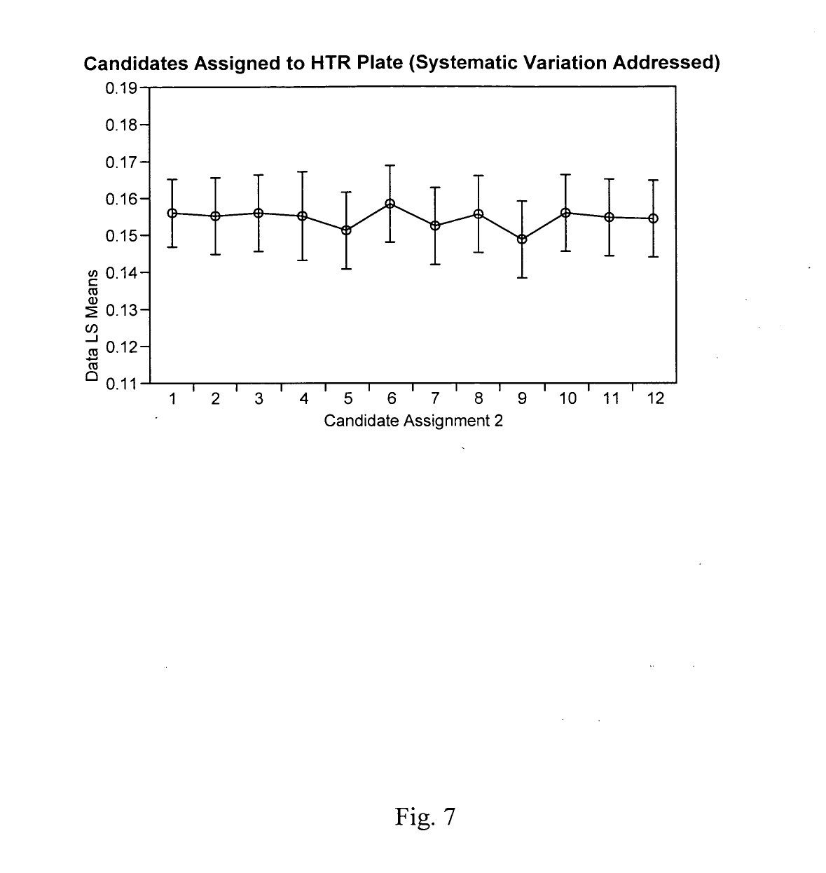

FIG. 7 shows the analysis plot based on the data collected when using the assignment as shown in Table 17. Because a balanced assignment of the candidates between the upper and lower levels of the plate has been provided, blocking can be utilized in the analysis to account for the level variability and compare the candidates on equal terms.

FIG. 7 shows there is no significant differences between the identical candidates when utilizing a balanced assignment of the candidates to the plate positions and blocking the unavoidable variation which is the known source of systematic variation due to plate levels.

A comparison of FIG. 6 and FIG. 7 illustrates the importance of understanding and quantifying systematic variation in the pre-design phase, and the importance of providing a screening design in the design phase that assigns the candidates to the high throughput research system plate positions so that the workflow process produces statistically defensible data. This example illustrates that sources of unavoidable variation may be present within the high throughput research system, and that following the method, as provided herein, can effectively produce statistically defensible data via such high throughput research system, thus enabling reliable research to be conducted utilizing high throughput research systems.

What is claimed is:

1. A method for providing a workflow that produces statistically defensible data, the method comprising:
quantifying a systematic variation in a high throughput research system that is to process a candidate, wherein the high throughput research system has at least one physical attribute and at least one environmental attribute;
identifying a design objective for the candidate; and
developing an experimental design for the candidate, wherein the experimental design accounts for the quantified systematic variation and is at least based on the design objective to provide the workflow that produces statistically defensible data.

2. The method of claim 1, where quantifying systematic variation includes performing a variance component analysis on the high throughput research system.

3. The method of claim 2, where performing the variance component analysis includes performing a gauge repeatability and reproducibility study on the high throughput research system.

4. The method of claim 1, further comprising modifying a source of systematic variation within the high throughput research system to change the systematic variation.

5. The method of claim of claim 4, where modifying the source of systematic variation includes changing at least one physical attribute of the high throughput research system.

6. The method of claim of claim 4, where modifying the source of systematic variation includes changing at least one environmental attribute of the high throughput research system.

7. The method of claim 1, where developing the experimental design for the candidate includes blocking unavoidable, known systematic variation or randomizing unknown systematic variation to decrease bias effects on the workflow that produces statistically defensible data.

8. The method of claim 1, where developing the experimental design for the candidate includes developing at least one of a screening design, a split plot design of experiment, or a classical design of experiment.

9. The method of claim 8, where developing at least one of the screening design, the split plot design of experiment, or the classical design of experiment includes determining if there are restrictions in randomization of the high throughput research system and using the resulting determination to select between the split plot design of experiment and the classical design of experiment.

10. The method of claim 8, where developing at least one of the screening design, the split plot design of experiment, or the classical design of experiment includes developing a false positive rate and a false negative rate or determining a number of replications when the screening design is developed for the candidate.

11. A computer readable medium having instructions stored thereon for causing a computing device to perform a method comprising:
quantifying a systematic variation in a high throughput research system that is to process a candidate, wherein the high throughput research system has at least one physical attribute and at least one environmental attribute;
identifying a design objective for the candidate; and
developing an experimental design for the candidate, wherein the experimental design accounts for the quantified systematic variation and is at least based on the design objective to provide a workflow that produces statistically defensible data.

12. The medium of claim 11, where quantifying systematic variation includes performing a gauge repeatability and reproducibility study to evaluate a measurement system capability.

13. The medium of claim 11, where the method further comprises modifying a source of systematic variation within the high throughput research system to change the systematic variation.

14. The medium of claim 13, where modifying the source of systematic variation within the high throughput research system includes modifying at least one physical attribute of the high throughput research system.

15. The medium of claim 13, where modifying the source of systematic variation within the high throughput research system includes modifying at least one environmental attribute of the high throughput research system.

16. The medium of claim 11, where developing the experimental design for the candidate includes randomizing unknown systematic variation to decrease bias effects on the workflow that produces statistically defensible data.

17. The medium of claim 11, where developing the experimental design for the candidate includes blocking unavoidable, known systematic variation to decrease bias effects on the workflow that produces statistically defensible data, determining restrictions in randomization of the high throughput research system, or developing at least one of a screening design, a split plot design of experiment, or a classical design of experiment.

18. A computing device, comprising:
a processor;
a memory in communication with the processor; and
computer executable instructions stored in the memory and executable by the processor to:
perform a variance component analysis that quantifies a systematic variation on a high throughput research system that is to process a candidate;
identify a design objective for the candidate; and
develop an experimental design for the candidate, wherein the experimental design accounts for the quantified systematic variation and is at least based on the design objective to provide a workflow that produces statistically defensible data.

19. The device of claim 18, where the computer executable instructions stored in the memory and executable by the processor to perform the variance component analysis include instructions to perform a gauge repeatability and reproducibility study on the high throughput research system to evaluate a measurement system capability or to develop an experimental design include instructions to provide blocking to decrease bias effects on the workflow that produces statistically defensible data.

20. The device of claim 18, where the computer executable instructions stored in the memory and executable by the processor to develop the experimental design include instructions to determine restrictions in randomization of the high throughput research system or to develop at least one of a screening design, a split plot design of experiment, or a classical design of experiment.
